(19) United States
(12) Patent Application Publication
(10) Pub. No.: US 2004/0159699 A1
(43) Pub. Date: Aug. 19, 2004

(54) Peripheral point-of-sale systems and methods of using such

(75) Inventors: Eric M. Nelson, Waterloo, NE (US); James Price, Alpharetta, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/370,282

(22) Filed: Feb. 19, 2003

(51) Int. Cl. G06F 17/60

(52) U.S. Cl. 235/379

(57) ABSTRACT

A point-of-sale device useful in relation to a variety of circumstances and/or utilization methods. Various implementations of such point-of-sale devices are disclosed. For example, one particular point-of-sale device includes an audio player, a video player, and output devices for displaying audio and video. Other devices include a wedge shape design, while yet other devices include photocells for remote powering. Methods for using such devices can include, for example, loading various media objects to a media device.

### CROSS-REFERENCES TO RELATED APPLICATIONS

This application is related to U.S. patent application Ser. No. 09/634,901, entitled “Point-of-sale Payment System”, filed Aug. 9, 2000 by Randy J. Templeton et al., which is a nonprovisional of U.S. Prov. App. No. 60/147,899, entitled “Integrated Point-of-sale Device”, filed Aug. 9, 1999 by Randy Templeton et al., the entire disclosures of both are herein incorporated by reference for all purposes. Further, this application is related to U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”,U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith, and all of which were filed on Apr. 3, 2002 and are incorporated herein by reference for all purposes.

### BACKGROUND OF THE INVENTION

This invention relates to point-of-sale devices and to point-of-sale transactions. More particularly, this invention relates to an integrated point-of-sale device capable of facilitating transactions associated with one or more transaction systems.

In the sale of goods by a merchant to a customer, point-of-sale devices are used by the merchant to complete a transaction. For example, a common cash register can be used to tally the cost of items purchased, accept cash payments, and return the proper amount of change. In some cases, such a register can be used in conjunction with a credit card reader. More particularly, the merchant can ring up a total amount due on the register, pass the credit card through a card reader to debit the customer account, and in turn the register recognizes the payment by credit card. While devices for completing such transactions exist, the functionality of such devices is quite limited.

To overcome various limitations of devices in use at the point-of-sale, the present invention provides advanced point-of-sale devices and methods for using such.

### BRIEF SUMMARY OF THE INVENTION

Point-of-sale devices useful in relation to a variety of circumstances and/or utilization methods are disclosed herein. In some cases, such point-of-sale devices include media players for playing various audio and visual data. In addition, various embodiments of devices in accordance with the present invention include media bays through which media objects in electronic and/or magnetic form can be loaded to media devices. For example, in some cases, a media bay can be an opening into which a non-volatile memory card, or magnetic disk can be inserted. In other cases, the media bay can be a port, such as a USB connector through which electronic media can be loaded to a non-volatile memory card, or magnetic disk. Electronic media that can be loaded can include, but is not limited to, audio recordings, video recordings, computer software, electronic cash, cell phone minutes, digital information, and the like.

In various cases, such point-of-sale devices can include remote power sources, such as photocells that allow the devices to operate remotely. In addition, a wedge shaped design can be employed to make a display provided on the point-of-sale devices readily readable by a user. Further, in some cases, the wedge can be adjustable such that the angle of the display can be adjusted to an individual user. In particular cases, the point-of-sale device includes a deformable element that when placed on a persons leg can form to the persons leg. This can be an advantage where the person is disabled and has difficulty accessing the point-of-sale device. In such a case, the point-of-sale device can be handed to the disabled person, who then places the device on their leg and operates the device.

One particular embodiment of the present invention provides a point-of-sale device including a base portion attached to an interface portion. In some cases, the base portion comprises a stand suitable for mounting on a check out stand in a retail location. In other cases, the base portion is not mounted, but rather rests on the check out stand. In yet other cases, the base portion comprises a deformable element that makes the point-of-sale device more easily used by a handicapped user. In one particular case, the deformable element is a foam pad that is detachable from the base portion. Further, in the embodiment of the point-of-sale device, the interface portion includes a photocell and a media bay. As previously discussed, the media bay can be used to load electronic media to a media device. For example, the media bay can be an insertion location formed to accept the insertion of a smart card capable of being loaded with electronic media. Alternatively, the media bay can be an insertion location formed to accept the insertion of a non-volatile RAM card, or a magnetic disk. As yet another alternative, the media bay can be an electrical connector, such as a USB port, capable of attachment to a media device. The media device can be a non-volatile RAM card, a magnetic disk, a smart card, an MP3 audio player, a DVD player, and the like.

In particular embodiments, the interface portion and the base portion are attached to form a wedge shape. The interface portion is further moveable in relation to the base portion such that moving the interface portion in relation to the base portion modifies an angle of the wedge shape. In particular instances, the wedge shape is formed by attaching the interface portion and the base portion together at a pivot.

In some cases, the point-of-sale device further includes a magnetic strip reader, an audio player, and/or a video player. The interface portion can further include a display. The display can incorporate one or more of a touch screen and a pen interface.

Another embodiment of the present invention provides a point-of-sale device that includes a base portion and an interface portion that are attached at a pivot forming a wedge shape. The interface portion is moveable in relation to the base portion such that an angle of the wedge shape is modified. In some cases, the interface portion comprises a display, a photocell, and/or a media bay.

Yet another embodiment of the present invention provides a point-of-sale system that includes a plurality of point-of-sale devices. Each of the plurality of point-of-sale devices comprises an interface portion and a base portion that are attached at a pivot. The system further includes a server that is coupled to the plurality of point-of-sale devices via a communication network. In particular instances, the point-of-sale system further includes attaching one or more of the point-of-sale devices to the communication network via a point-of-sale base unit. In other instances, the point-of-sale system additionally includes a communication network between the server and outside information and/or servicing sources. In some cases, the communication network between the point-of-sale device and the server is a wireless network, and the communication network between the server and the other sources is a virtual private network.

Yet other embodiments of the present invention provide methods for distributing electronic media via a point-of-sale device. The methods include receiving a request for a media object via a point-of-sale device, accessing the requested media object, and loading the requested media object to a media device that is at least partially disposed within the point-of-sale device. Yet further embodiments include displaying and/or previewing the media object via the point-of-sale device. For example, an audio recording can be played via headphones or another audio output of the point-of-sale device. Further, visual outputs can be displayed on a display associated with the point-of-sale device. To this end, the point-of-sale device can further include audio codecs, video codecs, and/or software programs for performing the preview. Such can include, but are not limited to, MP3 and MPEG players. In some cases, the methods further include receiving payment for the media object at the point-of-sale device. Such media objects can be selected from, for example, audio recordings, video recordings, computer software, other information, and the like.

In some cases, the media device is disposed within a media bay of the point-of-sale device. The media device can be, for example, a magnetic recording media, a non-volatile electronic memory, a smart card, or other such device for accepting and storing media. In some cases, the method includes attaching a connector associated with the media device to the point-of-sale device. By attaching the connector, the media device comprising the connector is at least partially within the point-of-sale device. In such a case, the media device can be, for example, an MP3 player with an associated USB connector. The USB connector is attached to the point-of-sale device and electronic media is transferred via the USB connector to the MP3 player.

In various cases, the methods can include powering the point-of-sale device using a photocell. Further, the point-of-sale device can be coupled to a server via a communication network, such as a wireless communication network. In particular cases, the communication network is a first communication network, and the server is further coupled to a media object source via a second communication network. Such a media object source can provide access to various electronic media, such as, audio, video, and/or software.

This summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIGS. 1 and 2 illustrate point-of-sale systems in accordance with embodiments of the present invention;

FIG. 3 illustrates a point-of-sale device in accordance with various embodiments of the present invention;

FIG. 4 illustrates an exemplary media device useful in relation to embodiments of the present invention;

FIG. 5 illustrates a schematic diagram of the point-of-sale device of FIG. 3; and

FIG. 6 is a flow diagram illustrating one method of distributing media objects in accordance with an embodiment of the present invention.

### DETAILED DESCRIPTION OF THE INVENTION

Various embodiments of the present invention are directed to a common Point-of-Sale (“POS”) devices useful in a variety of circumstances and/or utilization methods. Further, some embodiments of the present invention provide for POS systems that utilize the POS devices. Such POS systems can be tailored for accessing and uploading data to a media device via the POS device. Such data can include, for example, audio recordings, video recordings, software, and the like. Yet further, in some embodiments, the POS devices can include one or more players capable of previewing the data to be uploaded, and payment acceptance functionality to accept payment for the data to be uploaded. Detail regarding this functionality and more is provided below.

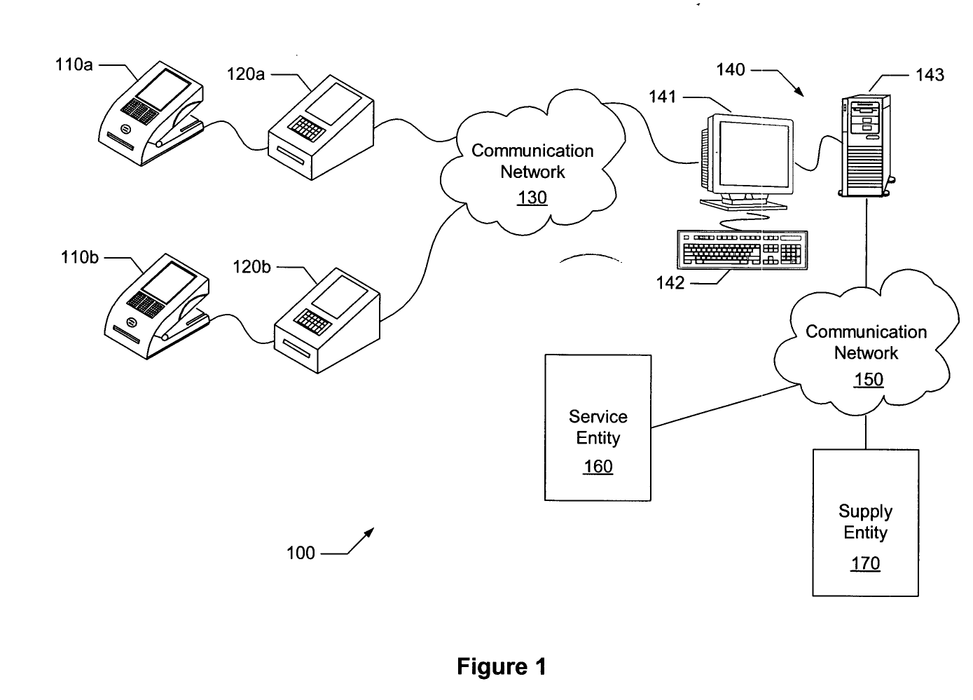

Turning to FIG. 1, a system 100 for effectuating a sale in accordance with embodiments of the present invention is described. System 100 includes one or more POS devices 110 tethered to one or more POS base stations 120. As will be evident from the proceeding discussion, system 100 can include any number of POS devices 110, and/or POS base terminals 120 in accordance with the various embodiments of the present invention.

POS base terminal 120 can include, but is not limited to, a display, a keypad, a magnetic-stripe card reader, an integrated roll printer, an integrated slip printer, other types of printers, a magnetic-ink character-recognition (“MICR”) reader, a smart card reader, a document imager, connection and/or communication ports including Ethernet and USB communications, a modem, a microphone, a speaker, a touch-screen, a card issuer, an operating system, software, and circuit cards, such as, sound cards and/or I/O cards. In addition, interfaces may be provided for connection with an external monitor and/or keyboard. In different embodiments, the POS base terminal comprises all or some of such components. Such components permit the POS base terminal to be used by merchants to process multiple types of electronic-payment and other transactions, including credit transactions, debit transactions, check transactions, money-transfer transactions, money-order sales, bill payments, management of customer-loyalty programs, issuance of coupons, acceptance of coupons, issuance of stored value cards, fraud detection associated with a variety of transaction types, and other such functions.

Further, in some cases, POS base terminal 120 can include a bi-directional printer. Such a bi-directional printer is capable of printing from left to right, from right to left, and vertically in one or both directions. Such a bi-directional printing capability is useful for a number of reasons. For example, such a printer can be used to frank a check. When the check is inserted in the slip printer and/or imager vertically, it is scanned by the imager and MICR reader for content. Such a process can be accomplished once on insertion of the check into POS base terminal 120 and then again on the exit. Then, in some cases, the slip printer prints the pay line of the check, which can include a ninety degree rotation of the print head. Once the printing is complete, the check is turned over by the clerk and placed back in slip printer and/or imager for franking the back of the check. Such franking of the back of the check can include receipt information, such as, a merchant number, a store name, a time stamp, a dollar amount, and the like.

Further, in some cases, the imager is capable of bi-directional imaging including up and down vertically and both directions horizontally. In one particular embodiment, such bi-directional imaging is accomplished using two imaging sources, one for horizontal and one for vertical. Various POS base terminals useful in relation to the present invention are disclosed in U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”, U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith and previously incorporated by reference for all purposes.

POS base terminals 120 are accessible to a server 140 via a communication network 130. Communication network 130 can be any network capable of transmitting and receiving information in relation to POS device(s) 110 and/or POS base terminal(s) 120. For example, communication network 130 can comprise a TCP/IP compliant virtual private network (“VPN”), the Internet, a local area network (“LAN”), a wide area network (“WAN”), a telephone network, a cellular telephone network, an optical network, a wireless network, or any other similar communication network. In particular embodiments, communication network 130 provides message based communications between POS device(s) 110 and/or POS base terminal(s) 120, and server 140.

In some embodiments, communication network 130 is a combination of a variety of network types. For example, in one embodiment, communication network comprises the Internet for communicating between POS device 110a and server 140, and a Virtual Private Network (“VPN”) for communicating between POS device 10b and server 140. In light of the disclosure provided herein, one of ordinary skill in the art will recognize a number of other network types and/or combinations thereof that are capable of facilitating communications between POS device(s) 110, POS base terminal(s) 120, and server 140.

Server 140 can include an input device 142, such as a keyboard, an output device 140, such as a monitor, and a server processor 143. In some embodiments, server 140 is maintained at a retail location and is responsible for communications to one or more POS device(s) 110 and/or POS base terminal(s) 120 located at the retail location.

Server 140 can be in communication with one or more service entities 160, and/or one or more supply entities 170 via a communication network 150. Communication network 150 can be a network such as that described in relation to communication network 130. In one particular embodiment, communication network 150 is the Internet.

Service entity 160 can be an entity that is responsible for programming either or both of POS device(s) 110 and/or POS base terminal(s) 120. For example, service entity 160 can be an entity that sells and services the various POS devices. As such, service entity 160 may make occasional changes or upgrades to the POS devices. Such changes and/or upgrades can include updating software operating on POS device(s) 110 and/or POS base terminal(s) 120. In some embodiments, service entity 160 performs one or more of the functions disclosed in relation to a function central control of U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”, U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith and previously incorporated by reference for all purposes.

Supply entity 170 can be a server or other entity that provides various data and/or media objects that can be uploaded to a media device via POS device(s) 110 and/or POS base terminal(s) 120. For example, supply entity 170 can be a store of audio recordings that can be selected and transferred to POS device 110 via the various communication networks and server 140. Alternatively, supply entity 170 can supply video titles, software titles, electronic credits such as cell phone minutes and/or electronic cash, or the like. In some cases, supply entity 170 is owned separate from server 140, while in other cases, supply entity 170 is commonly owned with server 140. Thus, for example, server 140 may be maintained at an individual video rental store, while supply entity 170 is maintained at a central location serving a number of commonly owned video rental stores. In other cases, server 140 can be maintained at a retail record store, and supply entity 170 is maintained remotely at a location operated by a record label. Based on the disclosure provided herein, one of ordinary skill in the art will recognize a myriad of other configurations for system 100 that are possible in accordance with the present invention.

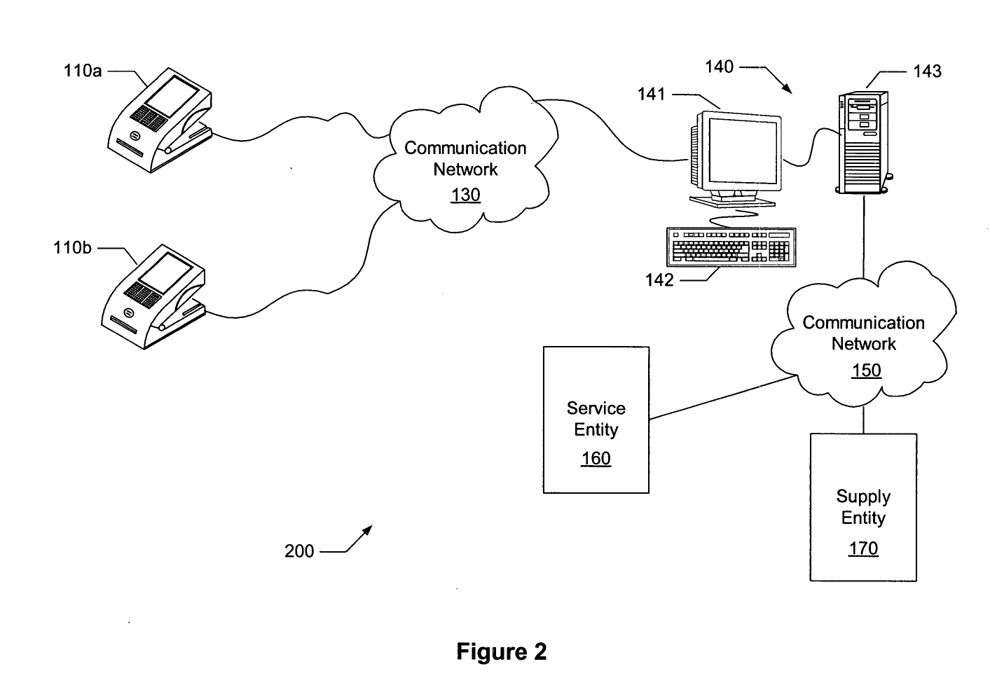

Turning to FIG. 2, another system 200 in accordance with embodiments of the present invention is depicted. System 200 is similar to system 100 with the exception that POS devices 110 are coupled directly to server 140 via communication network 130. System 200 can be tailored to embodiments where POS device 110 can be located in an individual's home, and server 140 and supply entity 170 co-located at a supplier's location. Of course, one of ordinary skill in the art will recognize other applications where system 200 would find applicability. In some cases, POS devices 110 are incorporated within, or in association with a personal computer (PC) owned by a consumer.

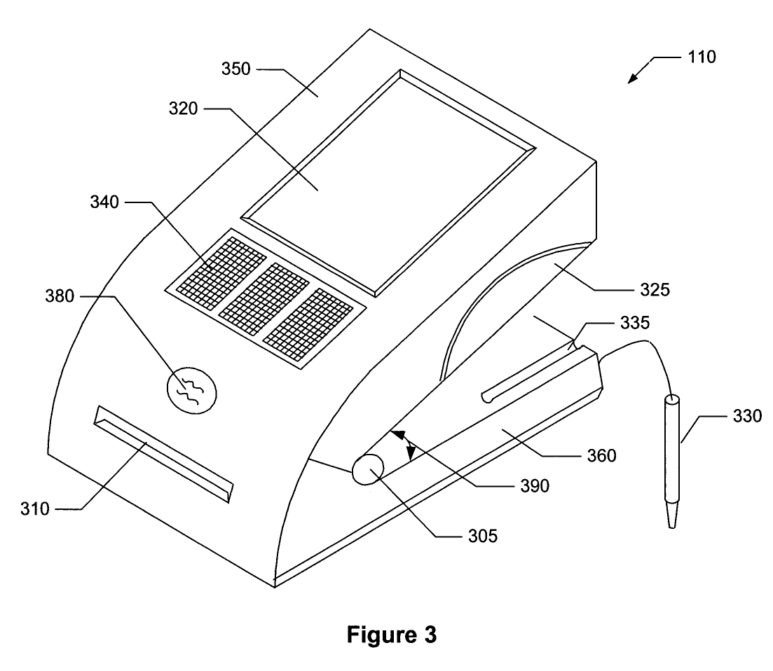

Referring to FIG. 3, an embodiment of a POS device 110 in accordance with the present invention is illustrated. In addition to the elements depicted in FIG. 3, POS device 110 can include a number of other elements. For example, POS device 110 can include, but are not limited to, a display, an electronic signature capture, a magnetic-stripe card reader, a smart card reader/writer, a PIN pad, and a security system. In different embodiments, the POS peripheral terminal comprises all or some of such components. Such components permit the POS peripheral terminal to be an interactive tool that allows customers to select their preferred transaction methods, view line-item details of transactions, and be provided with web-enabled electronic services, such as advertising (e.g., textual, graphics and/or video advertising) and coupons. More detail regarding such elements is provided in U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”, U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith and previously incorporated by reference for all purposes. As will be recognized from the discussion below, POS device(s) 110 can include components in addition to those previously listed, only a subset of those previously listed, or some combination of a subset of the previously listed components and additional components.

In some embodiments, POS device 110 can be a secure device which can interface with POS device 130, a Personal Computer (“PC”), an Electronic Cash Register (“ECR”), a Personal Digital Assistant (“PDA”), or other such devices. POS device 110 can provide functionality which is used by a consumer in a retail environment, such as Personal Identification Number (“PIN”) entry, clear text entry, signature capture, and the like. In various embodiments, POS device 110 can be used as a stand alone unit capable of operation apart from POS base terminal 120 or other such base devices.

Either separate or in conjunction with other devices such as a POS base terminal 120, POS device 110 can support a variety of functions together with a range of transactional services offered through a retailer maintaining POS device 110 and/or POS base terminal 120. Such transactional services can include, but are not limited to, money transfers, money orders, and/or checking and check guarantee services, uploading various media, and the like. In addition, the transactional services and/or supplying media can be provided by one or more third party suppliers maintaining service entities 160 and/or supply entities 170. Various uses are disclosed in U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”, U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith and previously incorporated by reference for all purposes.

In some embodiments, POS device 110 includes an RF frequency transceiver, or other wireless interconnect element allowing POS device 110 to be coupled to POS base terminal 120, or server 140 via a wireless communication network. Such a wireless communication network can be, for example, an IEEE 802.11 compliant wireless LAN, or the like.

As depicted in FIG. 3, POS device 110 includes a base portion 360 and an interface portion 350 attached by a pivot 305. POS device 110 further includes a media bay 310, a photocell array 340, a display 320, a speaker 380, a magnetic strip reader 325, a stylus 330 and a stylus holder 335. Base portion 360 and interface portion 350 are attached such that they form a wedge shape and are moveable relative to each other. Such moveability allows for moving display 320 to an angle most easily viewed by an end user. Thus, for example, where base portion 360 is mounted flat on a checkout stand, interface portion 350 can be moved such that a wedge angle 390 is reduced for a tall person, or increased for a short person. This provides an end user with an ability to obtain the greatest contrast available from display 320.

Photocell array 340 provides an ability to power POS device 110 without requiring access to outlet power. Thus, photocell array 340 can be any photocell technology capable of providing power to POS device 110 under ambient and/or natural lighting situations. In some cases, photocell array 340 provides for only part of the power requirements, while outlet power or power from a phone line provides for other power requirements. The magnetic strip reader can be capable of reading credit cards and/or other types of presentation instruments.

Media bay 310 can be any interconnection capable of coupling POS device 110 to a media device. In some cases, media bay 310 is an insertion slot tailored for receiving and accessing a media device, such as a smart card. Such accessing can include both reading and writing the smart card. In such cases, media bay 310 can read smart cards including, but not limited to, Siemens SLE4404 cards, Gemplus GPM103 cards, and/or SGS-Thompson ST1331 cards. 1

In other cases, media bay 310 is an insertion slot for receiving a media device, such as a PCMCIA card, a non-volatile RAM card of a form factor other than PCMCIA, or the like. Such a media device can then be associated with a player such as a DVD player, an MP3 player, a PC, or the like. In yet other embodiments, media bay 310 is a connector, such as a USB connector. A media device can be attached to POS device 110 via such a connector. A connector based approach is particularly advantageous when the media device is incorporated with a player, such as an MP3 player with built in memory.

In some cases, the underside of base portion 360 includes a deformable element, such as a foam pad. In other cases, the underside of base portion 360 includes an attachment area where such a deformable element can be attached to base portion 360. Adding such a deformable element can be advantageous where POS device 110 is to be placed on the leg of a person. The deformable element can conform to the surface of the person's leg thereby providing a more stable surface on which POS device 110 rests while it is used by a user. Based on the description provided herein, one of ordinary skill in the art will recognize a myriad of other applications aided by such a deformable element, and various other materials that can be used to make such a deformable element.

Display 320 can be any type of display capable of presenting transaction relevant information to a user. Further display 320 can be used to preview video titles and/or software titles to a user. In some cases, display 320 is a standard one-quarter VGA screen offering a resolution of 320 by 420 pixels. Alternatively, display 320 can be a backlit graphic Liquid Crystal Display (“LCD”) of the chip on glass type, having eight lines by twenty characters, or one-hundred, twenty-eight by sixty-four pixels. Such a display can be either color or monochromatic. Display 320 can incorporate one or both of touch screen capability and pen interface capability. Such a touch screen display can use capacitive touch technology, while in other cases, the screen can use resistive touch technology. Both signature capture and touch capture can be implemented on the same areas of the display. In some cases, the signature is captured at 300 dots per inch.

The magnetic strip reader can be a three track bi-directional reader. Such a magnetic-strip reader can decode International Organization for Standardization (“ISO”) tracks 1, 2, 3 information from a magnetic-strip on the same side of a card. Either alternatively, or in addition, the magnetic-strip reader can decode Japanese Industrial Standard (“JIS”) information located on a magnetic-stripe on the card side opposite the ISO tracks 1, 2, 3. Such JIS information can also conform to a physical standard for the location of the magnetic-strip on the card which is in a different location from ISO standard strips. Alternatively, or in addition, the magnetic-strip reader can be compliant with standards promulgated by the American National Standards Institute (“ANSI”), American Association of Motor Vehicle Administrators (“AAMVA”), and Commercial Drivers License (“CDL”). Information about other magnetic strip readers and displays including touch screen and pen interfaces useful in relation to the present invention are provided in U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”, U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith and previously incorporated by reference for all purposes.

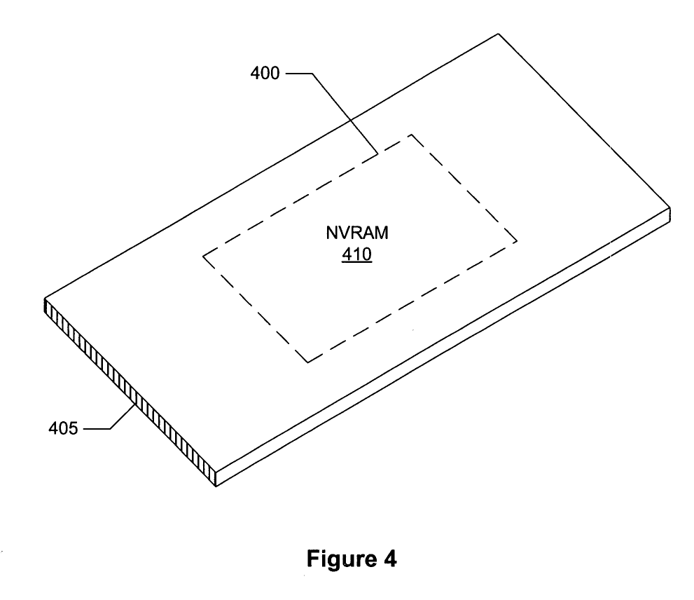

Referring now to FIG. 4, an exemplary media device 400 is illustrated. Exemplary media device 400 is a non-volatile RAM 410 encased and associated with an electrical interface 405. Of course, as previously described, media devices useful in relation to the present invention can be of many forms and/or form factors. For example, a media device may be a magnetically recorded diskette, such as a floppy disk. Alternatively, a media device can be a CDROM, a RAM based device, or a player integrated device such as an MP3 player. Based on the disclosure provided herein, one of ordinary skill in the art will recognize a variety of other media devices that can be used in relation to the present invention.

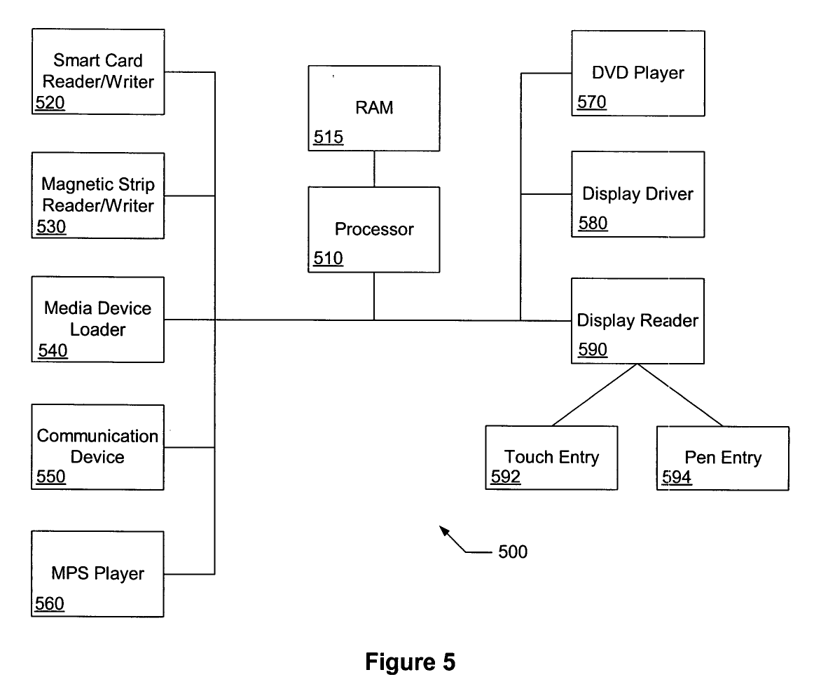

Referring now to FIG. 5, a logical block diagram 500 of one embodiment of POS device 110 is illustrated. POS device 110 includes a Central Processing Unit (“CPU”) 510 electrically coupled to a memory 515, a smart card reader 520, a magnetic strip reader 530, a media device loader 540, a communication device 550, an MP3 player 560, a DVD player 570, a display driver 580, and a display reader 590 including a touch entry interface 592 and a pen entry interface 594.

CPU 510 can be any microprocessor capable of controlling the various functions of POS device 110 described herein. In some embodiments, CPU 510 is a thirty-two bit Reduced Instruction Set Computer (“RISC”) processor. In one particular embodiment, CPU 510 is a Motorola 68302 processor. In other embodiments, CPU 510 is a pair of 32-bit processors one tasked to control the various components associated with POS device 110, and the other processor tasked with operating the various software applications executed in relation to POS device 110.

Smart card reader/writer 520 provides functionality used to read and write information to and from various smart cards. In some embodiments, smart cards are inserted via media bay 310 and smart card reader/writer 520 is electrically coupled to the interface circuitry of media bay 310.

Communication device 550 can be a circuit implementing a communication mechanism capable of transmitting and receiving information across communication network 130. In some embodiments, communication device 550 includes an ISDN modem, while in other embodiments, communication device 550 includes a wireless modem and an antenna associated therewith. Based on the disclosure provided herein, one of ordinary skill in the art will recognize a number of communication types and/or circuits that can be employed in relation to communication device 550.

Media device loader 540 can be a circuit capable of receiving data and loading it to a media device coupled to media bay 310. Thus, for example, where a media device has a PCMCIA interface, media device loader 540 can support loading a media device via a PCMCIA interface. Alternatively, where a USB interface is used, media device loader 540 can support loading a media device via a USB interface. Based on the disclosure provided herein, one of ordinary skill in the art will recognize a number of other interfaces that can be supported and circuitry associated therewith.

MP3 player 560 and DVD player 570 can be incorporated to preview various media that can be loaded via POS device 110. For example, an audio recording may be accessed by POS device 110, and played by MP3 player 560 with the output being provided to speaker 380, or through an external audio connector associated with POS device 110. Alternatively, a video recording may be accessed by POS device 110, and played by MP3 player 560 and DVD player 570 with the output being provided to speaker 380 and display 320. As yet another alternative, a video game or software program may be accessed by POS device 110, and played by MP3 player 560 with the output being provided to speaker 380. In some cases, CPU 510 can be intimately involved in the preview, or in other cases, may play only a minor roll. Indeed, in some cases, MP3 player 560 and/or DVD player 570 may be implemented primarily via software running on CPU 510. Based on the disclosure provided herein, one of ordinary skill in the art will recognize a myriad of other hardware and/or software players that can be used in place of, or in addition to, MP3 player 560 and DVD player 570.

Display 320 can be driven via a display driver 580, which in some cases is a graphics controller. Further, display reader 590 provides for receiving input via display 320. Such input can be received via a touch entry interface circuit 592, and a pen entry interface circuit 594.

Based on the disclosure provided herein, one of ordinary skill in the art will recognize other functionality that can be incorporated into POS device 110. For example, a wireless interface may be incorporated for reading a transponder carried on a key chain of a user. Some of this additional functionality is more fully disclosed in U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”, U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith and previously incorporated by reference for all purposes.

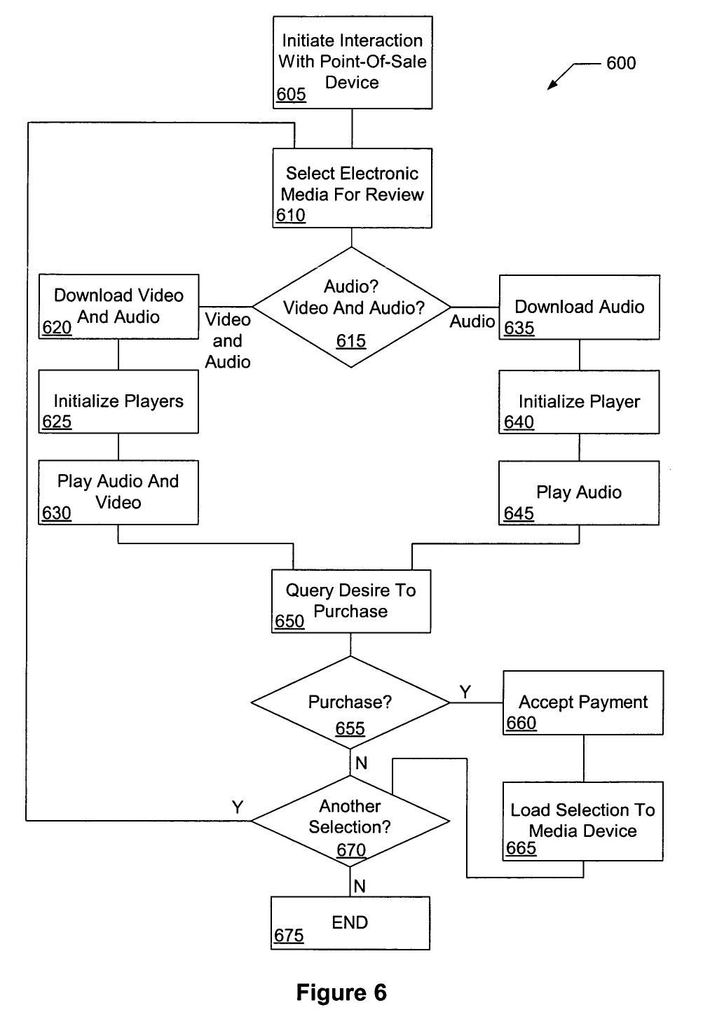

POS device 110 and/or the aforementioned systems can be used in relation to a number of methods. For example, POS device 110 and a system in which it resides can be used to implement a novel media distribution system such as that depicted by a flow diagram 600 of FIG. 6. Following flow diagram 600, an interaction with POS device 110 is initiated by a user (block 605). This can include a user swiping a credit card through magnetic strip reader 325, inserting a media device into media bay 310, touching display 320, or any other activity that allows POS device 110 to identify that a user desires to interact with POS device 110. In some cases, such as by swiping a credit card, a user is identified to POS device 110 and a welcome message displayed.

A user selects a media object for review and possible purchase (block 610). This can be done by selecting through a tree menu for a particular media object. For example, in a record store, a user may select a particular genre of music, and be presented by an alphabetical listing of artists producing music of that genre. The user can then select from the list of artists and be provided with a list of albums and/or single songs available from the artist. The selected song, or songs from a selected album can then be accessed by POS device 110 and previewed for the user via POS device 110 as described below.

It can be determined whether the selection includes an audio, a video, or both types of material for display (block 615). Thus, for example, where a recording as previously described is selected, it is determined that it is an audio only selection. Alternatively, where a movie is selected, it is determined that both audio and video portions exist. As yet another alternative, a software selection without audio functionality may be selected, and in such a case a video only selection has been made.

Where a selection involves both audio and video (block 615), both the audio and video are downloaded from server 140 (block 620). In some cases, such as MPEG, the audio and video are combined in a single format. In other cases, the audio and video are accessed via separate files. Further, in some cases where server 140 does not have a copy of the selection, server 140 can access the selection from supply entity 170 via communication network 150. The various players for both video and audio are then initialized (block 625). In some cases, this can include initializing DVD player 570 and MP3 player 560. The initialized players are then utilized to play the audio and video portions which can be output through speaker 380 or an external audio connector, and the video can be output via display 320.

A similar process can be followed where the selection involves only audio playback (block 615). The audio selection can be accessed by POS device 110 (block 635), an audio player initialized (block 640), and the selected audio player (block 645). Where video only is involved, a similar process can also be implemented where the video player is initialized and used, while leaving the audio player unused.

Once the selection has been played, or a preview portion thereof, display 320 and/or speaker 380 are utilized to query a user about whether they desire to purchase the selection (block 650). A user's desire to purchase the selection can be communicated by touching display 320 at a defined location, by swiping a credit card through magnetic strip reader 325, or by some other means. Where the user indicates that they would like to purchase the selection (block 655), payment is provided via POS device 110 and accepted thereby (block 660). Payment can be done by swiping a credit card, a debit card, a stored value card, or the like through magnetic strip reader. Alternatively, a media device inserted in media bay 310 may include payment information. As such, the payment information can be entered via media bay 310. As yet another alternative, electronic funds transfer information via the touch screen of display 320. The provided information is then verified by access to server 140, that in turn accesses the paying entity to verify funds. With the payment accepted, the selection is loaded to a media device inserted in media bay 310 (block 665). The user is then queried via speaker 380, display 320, or both about whether they would like to make another selection. Where another selection is desired (block 670), the process of selection, preview, and payment is repeated (blocks 610 through 645).

Where a user does not desire to purchase the selection (block 655), the user can be asked if they would like to make another selection. Where the user desires to make another selection (block 670), the process of selection, preview, and payment is repeated (blocks 610 through 645). Alternatively, the process is ended (block 675) where another selection is not desired.

Of course, POS device 110 and the aforementioned systems can be used in relation to many other methods. A variety of such methods are described in U.S. patent application Ser. No. 10/116,689, entitled “Systems And Methods For Performing Transactions At A Point-Of-Sale”; U.S. patent application Ser. No. 10/116,733, entitled “Systems and Methods for Deploying a Point-of-Sale System”, U.S. patent application Ser. No. 10/116,686, entitled “Systems and Methods for Utilizing a Point-of-Sale System”, and U.S. patent application Ser. No. 10/116,735, entitled “Systems and Methods for Configuring a Point-of-Sale System”, each assigned to an entity common herewith and previously incorporated by reference for all purposes.

The invention has now been described in detail for purposes of clarity and understanding. However, it will be appreciated that certain changes and modifications may be practiced within the scope of the appended claims. For example, any number of function central controls 110 can be used in relation to any number of POS devices 130 and/or POS peripherals 140. Further, the functions of the systems and methods of using such are merely exemplary. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A point-of-sale device comprising:
a base portion and an interface portion, wherein the base portion and the interface portion are attached; and
wherein the interface portion comprises a photocell and a media bay.

2. The point-of-sale device of claim 1, wherein the interface portion and the base portion are attached to form a wedge shape, and wherein the interface portion is moveable in relation to the base portion.

3. The point-of-sale device of claim 2, wherein moving the interface portion in relation to the base portion modifies an angle of the wedge shape.

4. The point-of-sale device of claim 1, wherein the base portion and the interface portion are attached at a pivot.

5. The point-of-sale device of claim 1, the point-of-sale device further comprising:
a magnetic strip reader.

6. The point-of-sale device of claim 1, the interface portion further comprising:
a display.

7. The point-of-sale device of claim 5, wherein the display further comprises:
a touch screen.

8. The point-of-sale device of claim 5, wherein the display further comprises:
a pen interface.

9. The point-of-sale device of claim 1, wherein the media bay is formed to accept and read a smart card.

10. The point-of-sale device of claim 1, wherein the media bay is formed to accept and load a media object to a media device.

11. The point-of-sale device of claim 1, wherein the point-of-sale device further comprises an audio player.

12. The point-of-sale device of claim 1, wherein the point-of-sale device further comprises a video player.

13. The point-of-sale device of claim 1, wherein the base portion comprises a deformable element operable to form to the leg of a user.

14. A method for distributing electronic media via a point-of-sale device, the method comprising:
receiving a request for a media object via a point-of-sale device,
accessing the requested media object; and
loading the requested media object to a media device that is at least partially disposed within the point-of-sale device.

15. The method of claim 14, wherein the media device is disposed within a media bay of the point-of-sale device.

16. The method of claim 14, wherein the media device comprises a magnetic recording media.

17. The method of claim 14, wherein the media device comprises a non-volatile electronic memory.

18. The method of claim 14, wherein the media device comprises a connector, and wherein the method further comprises:
attaching the connector to the point-of-sale device.

19. The method of claim 14, the method further comprising:
powering the point-of-sale device using a photocell.

20. The method of claim 14, wherein the point-of-sale device is coupled to a server via a communication network.

21. The method of claim 20, wherein the communication network is a wireless communication network.

22. The method of claim 20, wherein the communication network is a first communication network, and wherein the server is coupled to a media object source via a second communication network.

23. The method of claim 14, the method further comprising:
receiving payment for the media object via the point-of-sale device.

24. The method of claim 14, wherein the media object is selected from a group consisting of: an audio recording, a video recording, a computer software program, and electronic funds.

25. A point-of-sale device comprising:
a base portion and an interface portion, wherein the base portion and the interface portion are attached at a pivot forming a wedge shape, and wherein the interface portion is moveable in relation to the base portion such that an angle of the wedge shape is modified; and
wherein the interface portion comprises a display.

26. The point-of-sale device of claim 25, wherein the interface portion further comprises a photocell.

27. The point-of-sale device of claim 25, wherein the display comprises a touch screen.

28. The point-of-sale device of claim 25, wherein the point-of-sale device further comprises a media bay.

29. The point-of-sale device of claim 28, wherein the media bay is formed to load electronic data to a media device.

30. A point-of-sale system, the point-of-sale system comprising:
a plurality of point-of-sale devices, wherein each of the plurality of point-of-sale devices comprise an interface portion and a base portion, wherein the base portion and the interface portion are attached at a pivot;
a server, wherein the server is coupled to the plurality of point-of-sale devices via a communication network.

31. The point-of-sale system of claim 30, wherein at least one of the plurality of point-of-sale devices is coupled to the communication network via a point-of-sale base unit.

32. The point-of-sale system of claim 30, wherein the communication network is a first communication network, and wherein the server is further coupled to a second communication network.
